(19) United States
(12) Patent Application Publication
(10) Pub. No.: US 2022/0350820 A1
(43) Pub. Date: Nov. 3, 2022

(54) MUTUALLY EXCLUSIVE FEATURE DETECTION IN AN EVOLVING DISTRIBUTED SYSTEM

(71) Applicant: VMware, Inc., Palo Alto, CA (US)

(72) Inventors: Tao XIE, Shanghai (CN); Zhao JIN, Shanghai (CN); YangYang ZHANG, Shanghai (CN); Wei FANG, Shanghai (CN); Lei ZHOU, Shanghai (CN)

(73) Assignee: VMware, Inc., Palo Alto, CA (US)

(21) Appl. No.: 17/243,578

(22) Filed: Apr. 29, 2021

(51) Int. Cl. G06F 16/28; G06F 16/22; G06F 9/4401; G06F 16/182

(52) U.S. Cl. CPC G06F 16/285; G06F 16/2282; G06F 9/4401; G06F 16/182

(57) ABSTRACT

A distributed system, such as a distributed storage system in a virtualized computing environment and having storage nodes arranged in a cluster, is provided with capability by a management server to detect mutually exclusive features. If a feature being requested for installation is detected as being a mutually exclusive feature by using a first table, the management server searches for the feature in second table. If the feature is located in the second table and if the feature meets a condition for interoperability specified by the second table, then the management server proceeds with serving the request by installing the feature in the distributed storage system. Else, the management server rejects the request.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

A software-defined approach may be used to create shared storage for VMs, thereby providing a distributed storage system in a virtualized computing environment. Such software-defined approach virtualizes the local physical storage resources of each of the hosts and turns the storage resources into pools of storage that can be divided and assigned to VMs and their applications. The distributed storage system typically involves an arrangement of virtual storage nodes that communicate data with each other and with other devices.

For example, a distributed storage system may include a cluster of storage nodes such that the same piece of data is replicated in each storage node of the cluster. Storage nodes may be clustered together for this and other purposes, and a management server is typically provided to manage the operation of the cluster.

Distributed systems such as a distributed storage system are often in a state of evolution. For example, various new features (including plugins and their updates) may be added by the management server to the distributed system over time. However, due the nature of the features, the release schedule of the features, and other factors, there may be conflicts amongst the features being attempted to be added and currently installed features in the nodes. These conflicts make the process of adding features difficult and inefficient.

### BRIEF DESCRIPTION OF DRAWINGS

FIG. 1 is a schematic diagram illustrating an example virtualized computing environment having a distributed storage system that implements a method to detect and resolve mutually exclusive features for installation/configuration;

FIG. 2 is a schematic diagram illustrating further details of the distributed storage system of FIG. 1;

FIG. 3 shows examples of tables of features that may be used for the distributed storage system of FIG. 2;

FIG. 4 is a schematic diagram illustrating elements of the virtualized computing environment of FIG. 1 that may cooperate to use the tables of features of FIG. 3 for the in the distributed storage system of FIG. 2; and

FIG. 5 is a flowchart of an example method to detect and resolve mutually exclusive features for the virtualized computing environment of FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses the above-described and other drawbacks associated with providing features for a distributed system, such as a distributed storage system in a virtualized computing environment and having storage nodes arranged in a cluster. Capability is provided for a management server to detect mutually exclusive features. If a feature being requested for installation is detected as being a mutually exclusive feature by using a first table, the management server searches for the feature in second table. If the feature is located in the second table and if the feature meets a condition for interoperability specified by the second table, then the management server proceeds with serving the request by installing the feature in the distributed storage system. Else, the management server rejects the request, since the feature is confirmed to be a mutually exclusive feature that is not permitted to interoperate with at least one other feature for the distributed storage system.

### Computing Environment

In some embodiments, the technology described herein may be implemented in a distributed storage system provided in a virtualized computing environment, wherein the distributed storage system includes clusters of storage nodes. In other embodiments, the technology may be implemented in a storage system provided in other types of computing environments (which may not necessarily involve a virtualized computing environment), such as a storage system having clusters of physical storage devices that store data. For still other embodiments, the technology may be implemented for other types of nodes in a computing environment, alternatively or additionally to storage nodes in a distributed storage system. For the sake of illustration and explanation, the various embodiments will be described below in the context of storage nodes in a distributed storage system provided in a virtualized computing environment.

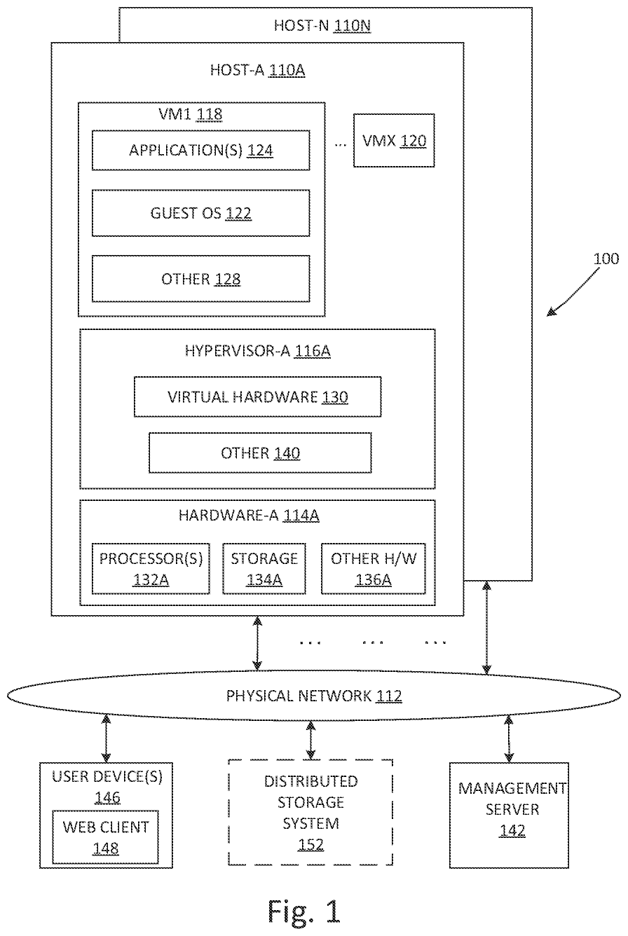

Various implementations will now be explained in more detail using FIG. 1, which is a schematic diagram illustrating an example virtualized computing environment 100 that can provide distributed storage functionality. More specifically, FIG. 1 is a schematic diagram illustrating an example virtualized computing environment 100 having a distributed storage system that implements a method to detect and resolve mutually exclusive features for installation/configuration. For example, such features may be updates, patches, new installations, etc. of plugins or other code that are to be applied to storage nodes in the distributed storage system. Depending on the desired implementation, the virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., hypervisor-A 116A) to support various virtual machines (VMs). For example, the host-A 110A supports VM1 118 . . . VMX 120. In practice, the virtualized computing environment 100 may include any number of hosts (also known as a “computing devices”, “host computers”, “host devices”, “physical servers”, “server systems”, “physical machines,” etc.), wherein each host may be supporting tens or hundreds of virtual machines. For the sake of simplicity, the details of only the single VM1 118 are shown and described herein.

VM1 118 may include a guest operating system (OS) 122 and one or more guest applications 124 (and their corresponding processes) that run on top of the guest operating system 122. VM1 118 may include still further other elements, generally depicted at 128, such as a virtual disk, virtual memory, agents, engines, modules, and/or other elements usable in connection with operating VM1 118.

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1118 and the other VMs. The hypervisor-A 116A may include still further other elements, generally depicted at 140, such as a virtual switch, agent(s), daemons, etc. In some embodiments and as will be described further below, one of these daemons in the hypervisor-A 116A may include a management daemon that is configured to determine the capabilities (e.g., installed features and/or related functionality) of host-A 116A, to report the capabilities and features to a management server 142, to perform installation/updates of features, etc.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

A distributed storage system 152 may be connected to or may be comprised of each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource(s) 134A of the host-A 110A and the corresponding storage resource(s) of each of the other hosts) can be aggregated together to form a shared pool of storage in the distributed storage system 152 that is accessible to and shared by each of the host-A 110A . . . host-N 110N, and such that virtual machines supported by these hosts may access the pool of storage to store data. In this manner, the distributed storage system 152 is shown in broken lines in FIG. 1, so as to symbolically convey that the distributed storage system 152 is formed as a virtual/logical arrangement of the physical storage devices (e.g., the storage resource(s) 134A of host-A 110A) located in the host-A 110A . . . host-N 110N. However, in addition to these storage resources, the distributed storage system 152 may also include stand-alone storage devices that may not necessarily be a part of or located in any particular host.

The management server 142 or other management entity of one embodiment can take the form of a physical computer with functionality to manage or otherwise control the operation of host-A 110A . . . host-N 110N, including operations associated with the distributed storage system 152. In some embodiments, the functionality of the management server 142 can be implemented in a virtual appliance, for example in the form of a single-purpose VM that may be run on one of the hosts in a cluster or on a host that is not in the cluster of hosts. The management server 142 may be operable to collect usage data associated with the hosts and VMs, to configure and provision VMs, to activate or shut down VMs, to monitor health conditions and diagnose and remedy operational issues that pertain to health, and to perform other managerial tasks associated with the operation and use of the various elements in the virtualized computing environment 100 (including managing the operation of the distributed storage system 152). In one embodiment and as will be further described below, the management server 142 may be configured to perform various operations associated with managing the features of the nodes in the distributed storage system 152, such as detecting mutually exclusive features that are currently installed in or that are to be applied to the storage nodes, determining capabilities of the storage nodes, resolving conflicts between features so as to determine whether to permit or not permit a feature to be applied to the storage node(s), etc.

The management server 142 may be a physical computer that provides a management console and other tools that are directly or remotely accessible to a system administrator or other user. The management server 142 may be communicatively coupled to host-A 110A . . . host-N 110N (and hence communicatively coupled to the virtual machines, hypervisors, hardware, distributed storage system 152, etc.) via the physical network 112. The host-A 110A . . . host-N 110N may in turn be configured as a datacenter that is also managed by the management server 142. In some embodiments, the functionality of the management server 142 may be implemented in any of host-A 110A . . . host-N 110N, instead of being provided as a separate standalone device such as depicted in FIGS. 1.

A user may operate a user device 146 to access, via the physical network 112, the functionality of VM1 118 . . . VMX 120 (including operating the applications 124), using a web client 148. The user device 146 can be in the form of a computer, including desktop computers and portable computers (such as laptops and smart phones). In one embodiment, the user may be a system administrator that uses the web client 148 of the user device 146 to remotely communicate with the management server 142 via a management console for purposes of performing operations such as configuring, managing, diagnosing, remediating, etc. for the VMs and hosts (including providing a configuration specification having possibly mutually exclusive features that are to be applied for the storage nodes in the distributed storage system 152 and other operations associated with performing feature detection by the management server 142). The user may also be any general user, such as a consumer that is using the services (e.g., the application 124) provided by VM1 118 and/or using the distributed storage system 152.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

### Distributed Storage System With Mutually Exclusive Features

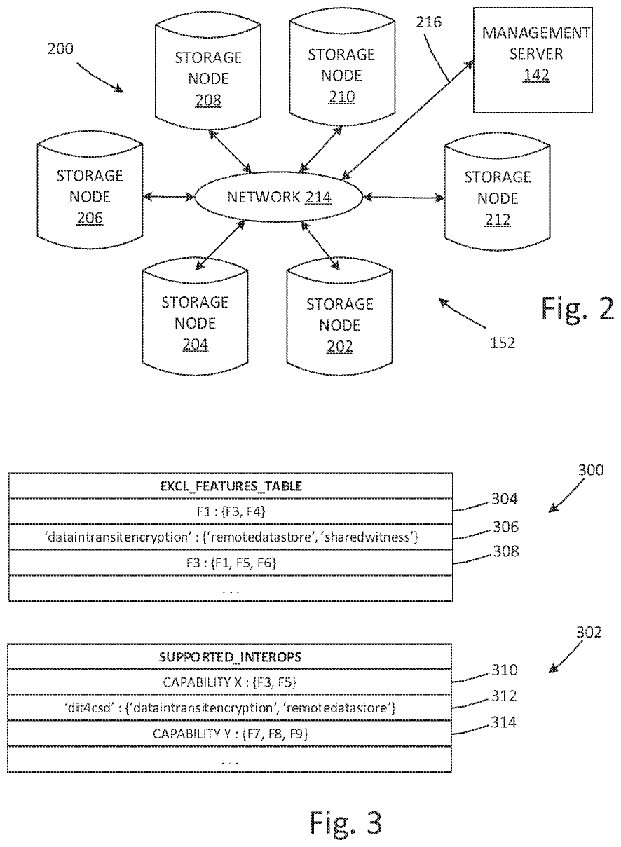

FIG. 2 is a schematic diagram illustrating further details of the distributed storage system 152 of FIG. 1. Specifically, FIG. 2 diagrammatically represents a cluster 200 of storage nodes 202-212 in the distributed storage system 152. As previously explained above with respect to FIG. 1, the various storage locations in the distributed storage system 152 may be provided by aggregating the respective physical storage resources of the hosts in FIG. 1. Thus, for example, the storage node 202 may be a virtual storage node that is formed by aggregating the storage resource 134A (or portion thereof) of host-A 110A and the storage resource (or portion thereof) of some other host(s). The other storage nodes 204, 206, 208, etc. may also be virtual storage nodes that are provided by aggregating storage resources (or portions thereof) of the various hosts in the virtualized computing environment 100. It is also possible for an individual one of the storage nodes 202-212 to be provided by only a single host, and also possible for a single host to allocate its storage resources for multiple storage nodes. Also, some of the storage nodes 202-212 may be a physical storage node in the form of a standalone storage device, rather than being a virtual storage node that is provided by way of an aggregation of storage resources.

Still further, new storage nodes may be added to the cluster 200, and storage nodes may be deleted from the cluster 200. The storage nodes in the cluster 200 may all have a common version of an operating system and/or management software, or may have mix of older and newer versions of these or other software amongst the storage nodes (e.g., a mixed mode arrangement within the cluster 200).

The storage nodes 202-212 may communicate with each other via a network 214. Moreover, entities outside of the distributed storage system 152 (such as VMs, user devices, external devices/networks, etc.) may communicate with one or more of the storage nodes 202-212 via the network 214. The network 214 may be a physical network (wired or wireless) or a logical network, which are provided/supported through the physical network 112 or other network/connections. The management server 142 can communicate with any of the storage nodes 200-212 via the network 214, in order to perform management operations for the distributed storage system 152, including applying or determining features for the storage modes 202-212. For example, the management server 142 can apply (generally depicted at 216) the features contained in a configuration specification to one or more of the storage nodes 202-212, can request capability or feature information (also generally depicted at 216), etc.

Each of the storage nodes 202-212 stores data associated with operating the virtual machines of the virtualized computing environment 100 and/or other types of data. This data may include data used or generated by the applications 124 or by the operating system(s), data that is uploaded to the distributed storage system 152 by a user, system/network health and performance data, and so forth. In implementations wherein the data is required to be current and consistent throughout the storage nodes, each of the storage nodes 200-212 will store the same data (e.g., the data is replicated in each of the storage nodes 200-212).

To perform configuration/reconfiguration in some distributed systems, such as in distributed storage systems, a management server validates a configuration specification and applies the changes contained in the configuration specification to all storage nodes in a cluster. Typically, the configuration specification may contain changes to multiple features, so as to improve the operation of the cluster. Either due to the nature of these features or due to release schedules, some of the features contained in the configuration specification may be conflict with each other and/or may be in conflict with currently installed features in the storage nodes. For example, a release version of a distributed storage system may support a hyperconverged infrastructure (HCI) mesh feature that enables cross-cluster sharing of resources and a data-in-transit (DIT) encryption feature, both of which are conflict with each other—as such, these two mutually exclusive features cannot be turned on (e.g., deployed) together at the same time on the same cluster.

As such, a distributed storage system may face the following potential issues:
1. The system supports a set of features [F1, F2, F3 . . . ], but there may be a conflict between some of the features (e.g., feature F1 and feature F2 are mutually exclusive).
2. The feature set increases in size as the system evolves and/or the compatibility of the features may change as the system evolves (e.g., in an earlier release version, feature F1 and feature F2 are conflict with each other; but in a later release version, feature F1 and feature F2 can co-exist).
3. The management server can manage both old and new nodes or mix mode nodes in a cluster.
4. Given an input configuration specification, the management server should validate the configuration specification. If there are features in the configuration specification whose operations conflict with each other, or conflict with the operations of features in the current state of the system, the management server should reject the configuration specification. Otherwise, if there are no such conflicted features, the management server should accept and apply the configuration specification to the cluster.

To handle the above challenges, distributed systems traditionally enable (one by one) features contained the configuration specification, and check whether the feature is conflicted with another feature contained in the configuration specification or conflicted with a feature that is already deployed in the system. If the management server detects a conflict, the management server rejects the entire configuration specification and generates an error message. It is then up to the end customer (or other entity) to improve or revise the configuration specification in a manner that addresses the conflict(s).

However, the foregoing traditional approach has several drawbacks:
1. The conflict checking is not done in an early stage. A conflict may be discovered after enabling some features, which may occur quite late and require a rolling back.
2. Each feature has its own exclusive feature conflict checking, which is not done in a centralized manner. For example, to perform a conflict check for a feature pair (A, B), a conflict check performed for feature A will check feature B's state, and vice versa. These are duplicative checks.
3. Moreover, feature A and B could be delivered in different releases, such that feature B is a new feature and feature A has already been released (deployed) previously. In this situation, the mutually exclusive checking for feature A has to be improved/updated, in order for that mutually exclusive checking to be capable of detecting feature B's state.
4. When the system evolves, two features can co-exist at a later release, and this is a more complicated situation because the management server should work-back compatible—the management server should support both old and new nodes or a mix mode. For example, if a conflicted feature pair (A, B) gets resolved in a new release, the conflict check for feature pair (A, B) should not be simply removed/omitted by the management server. Traditional approaches associate this conflict check with software versions, but there can be multiple versions in a software lifecycle, such a general availability (GA) release, updates, patch releases, etc. Such traditional approaches require a new statement for each new version, which is not ideal.

To address the above and other issues, various embodiments described herein provide a technique to validate a configuration specification, including detecting mutually exclusive features in a configuration specification and resolving any corresponding conflicts, such as by making a determination that there are no conflicts with currently deployed features (or, if conflicts are detected, rejecting the feature(s) that are proposed for installation). The technique may be implemented and works well in an evolving distributed system (such as the distributed storage system 152 of FIGS. 1 and 2) and supports backward compatibility and mixed mode environments. The technique may be based at least in part on building first and second tables (or other type of data structure), such as depicted in FIG. 3, that identify mutually exclusive features and allowed (non-conflicted) features.

More specifically, FIG. 3 shows examples of tables of features that may be used for the distributed storage system of FIG. 2, in particular a first table (EXCL_FEATURES_TABLE 300) and a second table (SUPPORTED_INTEROPS table 302). It is appreciated that the layout, content, naming conventions, etc. in the example tables 300 and 302 of FIG. 3 are merely for purposes of illustration and that other embodiments may implement other types of layout, content, naming conventions, etc. Moreover, while the tables 300 and 302 are each depicted as single tables, other embodiments may provide multiple tables, linked tables, sub-tables, etc., all of which may be referred to generically herein as a table. Still further, the embodiments are described herein in the context of and by referring to a table—other embodiments may use other types of data structure to store the same or similar content as the tables 300 and 302, which may not necessarily be in a table/tabular arrangement, but are nevertheless referred to herein as a table for purposes of simplicity of explanation.

With respect to the EXCL_FEATURES_TABLE 300, this table may be a global table that is used to declare mutually exclusive features. For each plugin or other code, the plugin/code can declare its own mutually exclusive feature information that specifies the conditions under which the plugin/code will encounter conflicts. Whether the plugin/code is built by the manufacturer/manager of the distributed storage system 152 or built by an outside third party, the plugin/code provides one or more declarations of its mutually exclusive features as part of the product documentation, for example.

During a system bootup sequence, the management server 142 loads all mutually exclusive feature declarations and fills in (loads) the fields in the EXCL_FEATURES_TABLE table 300 with this mutually exclusive feature information. Example fields (which can including sub-fields) are shown at 304, 306, and 308 in FIG. 3, and the various fields may have data contained therein that may be in the general form of:

‘particular feature having mutual exclusivity’ : {‘conflicted first feature’, ‘conflicted second feature’, ‘conflicted third feature’, . . . }

As an example, the information contained in the field 306 may have the following format:

‘dataintransitencryption’ : {‘remotedatastore’, ‘sharedwitness’}.

The above example denotes that the feature ‘dataintransitencryption’ cannot co-exist (e.g., is in conflict) with the two features ‘remotedatastore’ or ‘sharedwitness’. While two features are used in this example as being in conflict with the feature ‘dataintransitencryption’ the various fields may list one, two, or more features that are in conflict with a particular feature. Moreover, while the fields in the EXCL_FEATURES_TABLE table 300 may identify a single Boolean relationship in this example (e.g., an OR), more complicated and extended conditions and Boolean relationships may be specified in the EXCL_FEATURES_TABLE table 300.

With respect to the SUPPORTED_INTEROPS table 302, this table may be a dynamically built/updated table that indicates allowed/permitted interoperability relationships between features. The SUPPORTED_INTEROPS table 302 may include example fields (which can include sub-fields) 310, 312, and 314 having data contained therein that have been contributed (e.g., obtained from) deployed plugins (e.g., features) in the current state of the distributed storage system 152. Based on this information received from the plugins, the management server 142 can determine/generate the interoperability relationships shown in the SUPPORTED_INTEROPS table 302.

The various fields in the SUPPORTED_INTEROPS table 302 may have data contained therein that may be in the general form of:

‘particular capability’ : {‘deployed first feature’, ‘deployed second feature’, ‘deployed third feature’, . . . }

In the above example, a capability may represent one or more features, operations/results provided by the feature(s), or other characteristic of the cluster 200 as a whole (e.g., a host-level capability). In other embodiments, the SUPPORTED_INTEROPS table 302 may contain capability information for an individual storage node, alternatively or additionally to host-level capability information.

In an embodiment wherein each field/entry in the SUPPORTED_INTEROPS table 302 contains host-level capability information, an example of the information in the field 312 may be in the general form of:

‘dit4csd’ : (‘dataintransitencryption’, ‘remotedatastore’)

The above example entry in the SUPPORTED_INTEROPS table 302 indicates that if all storage nodes in the cluster 200 have the capability ‘dit4csd’, then the two currently deployed features ‘dataintransitencryption’ or ‘remotedatastore’ are able to co-exist with each other. Thus, even though the original plugin (feature) information in the EXCL_FEATURES_TABLE table 300 indicates that these two features are/were in conflict, the two features are now able to co-exist in the deployed version of the storage nodes in the cluster 200. Such a situation may occur, for example, wherein the two features ‘dataintransitencryption’ and ‘remotedatastore’ were mutually exclusive at some earlier deployment version of the distributed storage system 152, but then the distributed storage system 152 evolved over time to a current version wherein the two features ‘dataintransitencryption’ and ‘remotedatastore’ are now able to co-exist (e.g., they are no longer mutually exclusive of each other and can interoperate with each other if appropriate) whenever the current state of the cluster supports the capability ‘dit4csd’. Thus, the allowed interoperability information contained in the SUPPORTED_INTEROPS table 302 can possibly override the mutual exclusivity conditions specified in the EXCL_FEATURES_TABLE table 300.

While the fields in the SUPPORTED_INTEROPS table 302 may identify a relatively simple condition in this example (e.g., an OR relationship with an if/then condition), more complicated and extended relationship and conditions may be specified in the SUPPORTED_INTEROPS table 302. For example, nested interoperability conditions with multiple ORs, ANDs, and if/then relationships may exist and may be represented in the SUPPORTED_INTEROPS table 302.

The example capability ‘dit4csd’ and other capabilities can be reported by any of the storage nodes in the cluster 200 to the management server 142. For example, the management server 142 can use a GetCapabilities application program interface (API) to retrieve the capability information from each of the hosts.

Thus, when the management server 142 obtains this capability information, the management server 142 is able to determine which features in the cluster 200 are currently deployed and able to co-exist with each other for a particular capability, and can then determine the interoperability conditions and then populate the fields of the SUPPORTED_INTEROPS table 302 accordingly so as to specify the interoperability conditions. In some situations, the plugins may directly provide more extensive allowed interoperability conditions (instead of basic information such as the identification of installed features) to the management server 142 via the API, thereby avoiding the need for the management server 142 having to perform significant calculations to determine the allowed interoperability conditions.

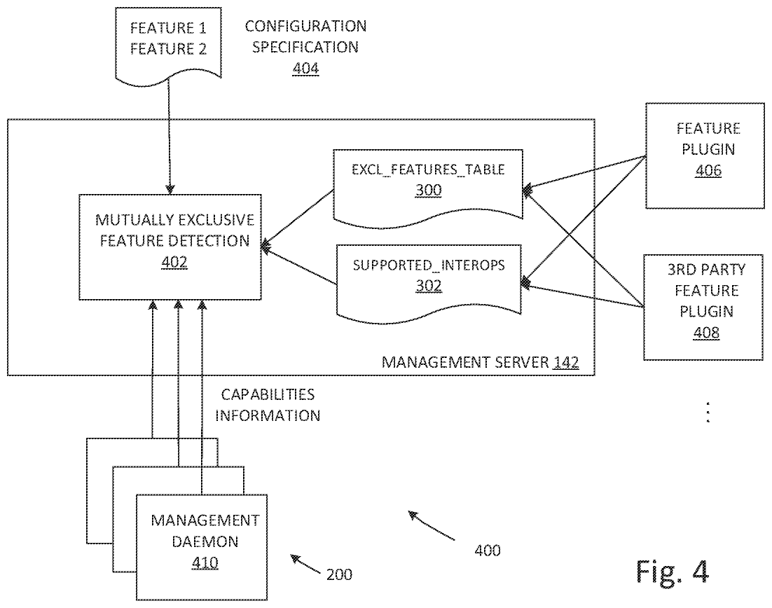

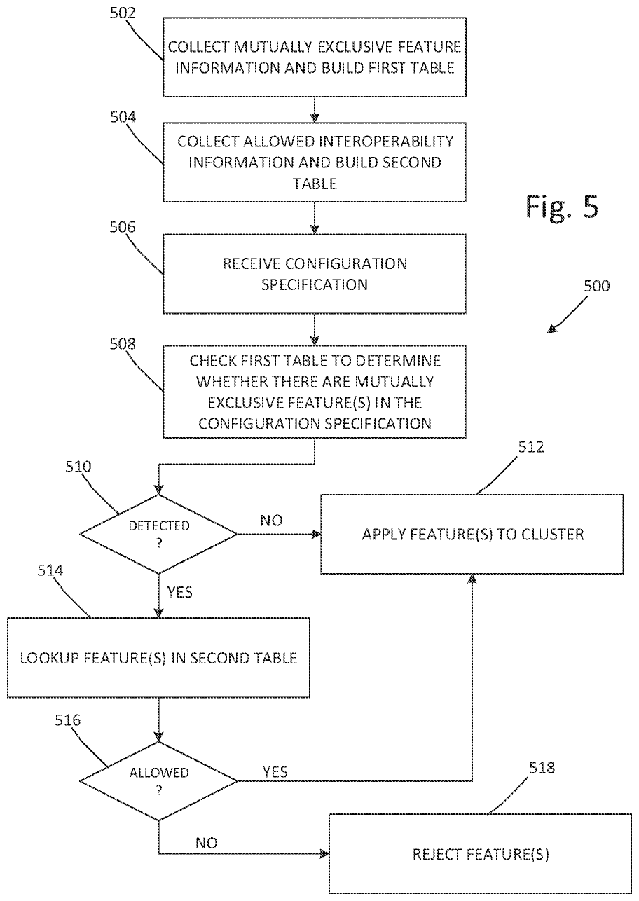

With appropriate API documentation, the capabilities and related API(s) may be made public to an end user. Therefore, the end user can check the capabilities in the distributed storage system 152 to verify that the configuration changes enumerated in a configuration specification are supported (e.g., interoperability will be allowed and will perform as desired) before sending a configuration request to the management server 142 to implement a configuration change enumerated by the configuration specification. After receipt of the configuration specification, the management server 142 can use the above API(s) to collect runtime system information about the cluster 200, so as to determine the capabilities of the cluster 200 and decide whether to accept or reject (e.g., resolve) the configuration changes set forth in the configuration specification. FIGS. 4 and 5 provide further details about the generation and use of the EXCL_FEATURES_TABLE table 300 and the SUPPORTED_INTEROPS table 302 for these purposes.

With respect to FIG. 4, FIG. 4 is a schematic diagram 400 illustrating elements of the virtualized computing environment 100 of FIG. 1 that may cooperate to use the tables 300 and 302 of features of FIG. 3 for the in the distributed storage system 152 of FIG. 2. The diagram shows the management server 142 generating and storing the EXCL_FEATURES_TABLE table 300 and the SUPPORTED_INTEROPS table 302.

The management server 142 may include a mutually exclusive feature detection module 402 that is configured to generate, update, maintain, etc. the EXCL_FEATURES_TABLE table 300 and the SUPPORTED_INTEROPS table 302. The module 402 of various embodiments may be embodied as code such as computer-readable instructions stored on a computer-readable medium and executable by one or more processors to perform the operations described herein pertaining to detecting mutually exclusive features and resolving these features to enable the management server 142 to apply or reject feature changes (requested in a configuration specification 404 received by the module 402) for the distributed storage system 152.

In one embodiment, the management server 142 collects the information to populate the EXCL_FEATURES_TABLE table 300 and the SUPPORTED_INTEROPS table 302 during the bootup sequence for the distributed storage system 152 and/or the bootup sequence for the management server 142. For example, a feature plugin 406, a third-party feature plugin 408, and various other plugins may be pre-existing (installed) in the cluster 300. Through API calls or other communication with these plugins, the module 402 may obtain mutually exclusive feature information from the declarations of these plugins, such as a particular feature's conflicts with other features (see, e.g., the information in the field 306 in FIG. 3), for populating into the EXCL_FEATURES_TABLE table 300. If necessary (such as if such mutually exclusive feature information is not readily available from an installed plugin), the module 142 can obtain such mutually exclusive feature information from some other internal or external source (e.g., from an outside developer's website documentation, from the configuration specification 404 if present therein, etc.).

Analogously, the management server 142 can obtain real-time allowed interoperability information, for populating the SUPPORTED_INTEROPS table 302, through API calls or other communication with these plugins. In some embodiments, the management server 142 may obtain/determine such allowed interoperability information from capabilities information provided by a management daemon 410 at a hypervisor of each host in the cluster 200. For instance, the management daemon 410 would know the capabilities, features, and plugin details at the host, and can report the capabilities to the module 402 in response to a GetCapabilities API call.

Based on the contents of the EXCL_FEATURES_TABLE table 300, the contents of the SUPPORTED_INTEROPS table 302 (which represent the real-time state of the distributed storage system 152), the requested state changes enumerated by the configuration specification 404 (e.g., a request to apply new features FEATURE 1, FEATURE 2, etc.), the management server 142 can detect whether there are any mutually exclusive features and resolve the request (e.g., apply the new features, or reject the new features). FIG. 5 provides more specific details of the operations performed by the elements shown in FIG. 4.

FIG. 5 is a flowchart of an example method 500 to detect and resolve mutually exclusive features for the virtualized computing environment 100 of FIG. 1. The method 500 can be performed in one embodiment by the module 402 of the management server 142, in cooperation with the nodes, hosts, hypervisor, and/or other elements in the cluster 200. The example method 500 may include one or more operations, functions, or actions illustrated by one or more blocks, such as blocks 502 to 518. The various blocks of the method 500 and/or of any other process(es) described herein may be combined into fewer blocks, divided into additional blocks, supplemented with further blocks, and/or eliminated based upon the desired implementation. In one embodiment, the operations of the method 500 and/or of any other process(es) described herein may be performed in a pipelined sequential manner. In other embodiments, some operations may be performed out-of-order, in parallel, etc.

The method 500 may begin at a block 502 (“COLLECT MUTUALLY EXCLUSIVE FEATURE INFORMATION AND BUILD FIRST TABLE”), wherein during the bootup sequence for the cluster 200 and/or for the management server 142, the management server 142 identifies the features that are deployed in the cluster 200 of the distributed storage system 152. The management server 142 may send, for example, API calls to the management daemons 410 of each host that requests the management daemons 410 to provide the declaration information for plugins. The management server 142 then reads these declarations to determine if any mutually feature exclusive information has been specified by the developer (or other entity) for the plugins. If the management server 142 identifies any such mutually exclusive feature information, then the management server 142 loads/populates the mutually exclusive feature information into the EXCL_FEATURES_TABLE table 300, such as the example information contained in the field 306 shown in FIGS. 3.

At a block 504 (“COLLECT ALLOWED INTEROPERABILITY INFORMATION AND BUILD SECOND TABLE”), the management server 142 determines the run-time (current) interoperability of the features installed in the cluster 200, and uses this interoperability information to populate the SUPPORTED_INTEROPS table 302. The block 504 may also be performed during the bootup sequence. For example, the management server 142 may send a GetCapabilities API call (or other type of API call or communication) to the management daemon 410 to request a report/list of the capabilities of each host. Then, through such discovery of the capabilities of each host (and therefore discovery of the capabilities at the cluster level) and by knowing the identity of the installed plugins (from block 502 above), the management server can determine/formulate the conditions under which interoperability of certain features are allowed, and then populate this allowed interoperability information into the SUPPORTED_INTEROPS table 302. For example and as shown in field 312, the two currently deployed features ‘dataintransitencryption’ or ‘remotedatastore’ are determined by the management server 142 to able to co-exist, if all of the storage nodes in the cluster 200 have the capability ‘dit4csd’.

The blocks 502 and 504 may be followed by a block 506 (“RECEIVE CONFIGURATION SPECIFICATION”), wherein the management server 142 receives a request to apply the configuration specification 404 to the cluster 200. The configuration specification 404 may specify an installation of one or more new features identified in the configuration specification 404 or some other change that involves features of the cluster 200.

The block 506 may be followed by a block 506 (“CHECK FIRST TABLE TO DETERMINE WHETHER THERE ARE MUTUALLY EXCLUSIVE FEATURE(S) IN THE CONFIGURATION SPECIFICATION”), wherein the management server 142 identifies feature(s) enumerated in the configuration specification, and determines/detects whether such feature(s) involve a mutually exclusive condition. For instance, the management server 142 may perform a lookup in the EXCL_FEATURES_TABLE table 300 to determine whether a mutually exclusive condition has been specified therein for a particular feature enumerated in the configuration specification 404. If such a condition is found in the EXCL_FEATURES_TABLE table 300, then the particular feature is considered by the management server 142 to be a mutually exclusive feature. If no such condition is found in the EXCL_FEATURES_TABLE table 300, then the particular feature is not considered by the management server 142 to be a mutually exclusive feature.

There may be a situation wherein the particular feature is indeed a mutually exclusive feature, but the particular feature is completely absent from the EXCL_FEATURES_TABLE table 300 when the checking is performed at the block 508. For example, the particular feature may be a recent release that has not been previously installed in the cluster 200 and so the management server 142 has not yet had an opportunity to populate the mutual exclusive information for the particular feature into the EXCL_FEATURES_TABLE table 300. Thus, the mere absence of the particular feature in the current version of the EXCL_FEATURES_TABLE table 300 does not necessarily mean that the particular feature is not subject to mutually exclusive conditions.

Hence at the block 508 and in addition to checking the EXCL_FEATURES_TABLE table 300, the management server 142 may try to locate mutual exclusive information for the particular feature from another information source, if the particular feature has been initially determined to be absent from the EXCL_FEATURES_TABLE table 300. For example, the configuration specification 404 may include the declaration or other information (including mutually exclusive feature information) for the particular feature/plugin, which the management sever 142 can in turn examine from the configuration specification 404 and load into the EXCL_FEATURES_TABLE table 300 for future use. As another example, the management server 142 can access the website of a developer for the particular plugin and obtain the mutual exclusive information from that source.

If, after performing the above operations at the block 508, the management server 142 does not determine/detect mutually exclusive conditions for the feature(s) enumerated in the configuration specification 404 (“NO” at a block 510), then the management server 142 proceeds with a cluster-wide application of the feature(s) enumerated in the configuration specification 404 to the cluster 200, at a block 512 (“APPLY FEATURE(S) TO CLUSTER”).

However, if after performing the above operations at the block 508, the management server 142 does determine/detect mutually exclusive conditions for the feature(s) enumerated in the configuration specification 404 (“YES” at the block 510), then the management server 142 searches the SUPPORTED_INTEROPS table 302 to determine whether the particular feature is identified therein, at a block 514 (“LOOKUP FEATURE(S) IN SECOND TABLE”).

For example, the SUPPORTED_INTEROPS table 302 has been previously populated (at the block 504) with conditions under which certain capabilities allow certain features to co-exist/interoperate. The management server 142 is thus able to check at the block 514: (a) whether the particular feature is identified anywhere in the SUPPORTED_INTEROPS table 302, and (b) if identified, whether a condition specified by the SUPPORTED_INTEROPS table 302 is met so as to enable the mutually exclusive nature of the particular feature to be overridden. The management server 142 may perform further GetCapabilities API calls at the block 514 to obtain new allowed interoperability information and/or updates thereof for the SUPPORTED_INTEROPS table 302, if needed.

If the management server 142 finds an explicit entry in the SUPPORTED_INTEROPS table 302 that allows interoperability for the particular feature (“YES” at a block 516), then the management server 142 proceeds with a cluster-wide application of the feature(s) enumerated in the configuration specification 404 to the cluster 200, at the block 512. That is, the feature has met the interoperability condition specified in the SUPPORTED_INTEROPS table 302. If, however, the management server 142 does not find an explicit entry in the SUPPORTED_INTEROPS table 302 for the particular feature (e.g., the feature is absent from the SUPPORTED_INTEROPS table 302) or if the management server 142 does find the particular feature in the SUPPORTED_INTEROPS table 302 but the condition(s) for allowing interoperability are not met, then the management server 142 rejects the requested installation of the particular feature, at a block 518 (“REJECT FEATURE(S)”).

The rejection at the block 518 may be an incremental rejection of the particular feature. That is, the entire configuration specification 404 need not be rejected—some features may be allowed for installation in the cluster 200, while some features may be rejected. In other situations, the entire configuration specification may be rejected at the block 518.

One advantage of the incremental nature is that, for both the EXCL_FEATURES_TABLE 300 and the SUPPORTED_INTEROPS table 302, new features (e.g., plugins) can declare its own statement without touching/affecting any existing features. The workload of the entire system/method is very light also, since the mutual exclusive checking is directed to the specific features for the system (rather than a generic global checking), and the checking itself is data driven, which is very convenient for developers on an open system.

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIG. 1 to FIG. 5.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment and/or storage nodes in distributed storage system), wherein it would be beneficial to detect and resolve mutually exclusive features.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

We claim:

1. A method to detect and resolve a mutually exclusive feature for a distributed system in a virtualized computing environment, the method comprising:
collecting mutually exclusive feature information and building a first data structure that includes the mutually exclusive feature information;
collecting allowed interoperability information for currently deployed features in the distributed system and building a second data structure that includes the allowed interoperability information;
receiving a configuration specification that enumerates at least one particular feature for installation in the distributed system;
checking the first data structure to determine whether the at least one particular feature meets a mutually exclusive condition specified by the mutually exclusive feature information;
in response to determination that the at least one particular feature meets the mutually exclusive feature condition, checking the second data structure to determine whether the at least one particular feature meets an interoperability condition specified by the interoperability information; and
in response to determination that the at least one particular feature, which is determined to meet the mutually exclusive feature condition, meets the interoperability condition, allowing the at least one particular feature to be installed in the distributed system.

2. The method of claim 1, wherein collecting the mutually exclusive feature information and the interoperability information is performed by a management server for the distributed system during a bootup sequence of the management server.

3. The method of claim 1, further comprising:
in response to determination that the at least one particular feature is not subject to any mutually exclusive feature condition specified by the mutually exclusive feature information, allowing the at least one particular feature to be installed in the distributed system; and
in response to determination that the at least one particular feature, which is determined to meet the mutually exclusive feature condition, does not meet the interoperability condition or that the second data structure is silent regarding the at least one particular feature, rejecting installation of the at least one particular feature in the distributed storage system.

4. The method of claim 1, wherein collecting the mutually exclusive feature information comprises reading the mutually exclusive feature information from at least one of: declarations of plugins that are currently deployed in the distributed system, declarations of plugins that are enumerated in the configuration specification, or declarations provided from a developer information site.

5. The method of claim 1, wherein collecting the allowed interoperability information for currently deployed features in the distributed system and building the second data structure that includes the allowed interoperability information comprises:
obtaining, by a management server for the distributed system, capability information from hosts in the distributed system; and
based on the capability information and based on identification of the currently deployed features in the distributed system, determining, by the management server, the interoperability condition.

6. The method of claim 1, wherein the first and second data structures comprise tables that are built and maintained by a management server for the distributed storage system.

7. The method of claim 1, wherein the distributed system includes a distributed storage system provided by the virtualized computing environment, and wherein the at least one particular feature is allowed to be installed in all storage nodes of a cluster in the distributed storage system in response to the interoperability condition being met.

8. A non-transitory computer-readable medium having instructions stored thereon, which in response to execution by one or more processors, cause the one or more processors to perform or control performance of a method to detect and resolve a mutually exclusive feature for a distributed system in a virtualized computing environment, wherein the method comprises:
collecting mutually exclusive feature information and building a first data structure that includes the mutually exclusive feature information;
collecting allowed interoperability information for currently deployed features in the distributed system and building a second data structure that includes the allowed interoperability information;
receiving a configuration specification that enumerates at least one particular feature for installation in the distributed system;
checking the first data structure to determine whether the at least one particular feature meets a mutually exclusive condition specified by the mutually exclusive feature information;
in response to determination that the at least one particular feature meets the mutually exclusive feature condition, checking the second data structure to determine whether the at least one particular feature meets an interoperability condition specified by the interoperability information; and
in response to determination that the at least one particular feature, which is determined to meet the mutually exclusive feature condition, meets the interoperability condition, allowing the at least one particular feature to be installed in the distributed system.

9. The non-transitory computer-readable medium of claim 8, wherein collecting the mutually exclusive feature information and the interoperability information is performed by a management server for the distributed system during a bootup sequence of the management server.

10. The non-transitory computer-readable medium of claim 8, wherein the method further comprises:
in response to determination that the at least one particular feature is not subject to any mutually exclusive feature condition specified by the mutually exclusive feature information, allowing the at least one particular feature to be installed in the distributed system; and
in response to determination that the at least one particular feature, which is determined to meet the mutually exclusive feature condition, does not meet the interoperability condition or that the second data structure is silent regarding the at least one particular feature, rejecting installation of the at least one particular feature in the distributed storage system.

11. The non-transitory computer-readable medium of claim 8, wherein collecting the mutually exclusive feature information comprises reading the mutually exclusive feature information from at least one of: declarations of plugins that are currently deployed in the distributed system, declarations of plugins that are enumerated in the configuration specification, or declarations provided from a developer information site.

12. The non-transitory computer-readable medium of claim 8, wherein collecting the allowed interoperability information for currently deployed features in the distributed system and building the second data structure that includes the allowed interoperability information comprises:
obtaining, by a management server for the distributed system, capability information from hosts in the distributed system; and
based on the capability information and based on identification of the currently deployed features in the distributed system, determining, by the management server, the interoperability condition.

13. The non-transitory computer-readable medium of claim 8, wherein the first and second data structures comprise tables that are built and maintained by a management server for the distributed storage system.

14. The non-transitory computer-readable medium of claim 8, wherein the distributed system includes a distributed storage system provided by the virtualized computing environment, and wherein the at least one particular feature is allowed to be installed in all storage nodes of a cluster in the distributed storage system in response to the interoperability condition being met.

15. A management server configured to detect and resolve a mutually exclusive feature for a distributed system in a virtualized computing environment, the management server comprising:
one or more processors; and
a non-transitory computer-readable medium coupled to the one or more processors, and having instructions stored thereon, which in response to execution by the one or more processors, cause the one or more processors to perform or control performance of operations that include:
collect mutually exclusive feature information and build a first data structure that includes the mutually exclusive feature information;
collect allowed interoperability information for currently deployed features in the distributed system and build a second data structure that includes the allowed interoperability information;
receive a configuration specification that enumerates at least one particular feature for installation in the distributed system;
check the first data structure to determine whether the at least one particular feature meets a mutually exclusive condition specified by the mutually exclusive feature information;
in response to determination that the at least one particular feature meets the mutually exclusive feature condition, check the second data structure to determine whether the at least one particular feature meets an interoperability condition specified by the interoperability information; and
in response to determination that the at least one particular feature, which is determined to meet the mutually exclusive feature condition, meets the interoperability condition, allow the at least one particular feature to be installed in the distributed system.

16. The management server of claim 15, wherein the management server performs collection of the mutually exclusive feature information and the interoperability information during a bootup sequence of the management server.

17. The management server of claim 15, wherein the operations further comprise:
in response to determination that the at least one particular feature is not subject to any mutually exclusive feature condition specified by the mutually exclusive feature information, allow the at least one particular feature to be installed in the distributed system; and
in response to determination that the at least one particular feature, which is determined to meet the mutually exclusive feature condition, does not meet the interoperability condition or that the second data structure is silent regarding the at least one particular feature, reject installation of the at least one particular feature in the distributed storage system.

18. The management server of claim 15, wherein to collect the mutually exclusive feature information, the instructions are executable to cause the one or more processors to perform or control performance of operations that include:
read the mutually exclusive feature information from at least one of: declarations of plugins that are currently deployed in the distributed system, declarations of plugins that are enumerated in the configuration specification, or declarations provided from a developer information site.

19. The management server of claim 15, wherein to collect the allowed interoperability information for currently deployed features in the distributed system and build the second data structure that includes the allowed interoperability information, the instructions are executable to cause the one or more processors to perform or control performance of operations that include:
obtain, by the management server, capability information from hosts in the distributed system; and
based on the capability information and based on identification of the currently deployed features in the distributed system, determine, by the management server, the interoperability condition.

20. The management server of claim 15, wherein the first and second data structures comprise tables that are built and maintained by the management server.

21. The management server of claim 15, wherein the distributed system includes a distributed storage system provided by the virtualized computing environment, and wherein the at least one particular feature is allowed to be installed in all storage nodes of a cluster in the distributed storage system in response to the interoperability condition being met.
